(19) United States
(12) Patent Application Publication
(10) Pub. No.: US 2004/0142192 A1
(43) Pub. Date: Jul. 22, 2004

(54) Coagulating agent and solution for the production of bi-component or multi-component glues, glueing method and corresponding device

(76) Inventors: Claude Hosotte, Sempach Station (CH); Damien Ferrand, Sempach Station (CH)

Correspondence Address: YOUNG & THOMPSON, 745 SOUTH 23RD STREET 2ND FLOOR, ARLINGTON, VA, 22202

(21) Appl. No.: 10/475,705

(22) PCT Filed: Apr. 23, 2002
(86) PCT No.: PCT/FR02/01390

(30) Foreign Application Priority Data
Apr. 24, 2001 (FR) 01/05527

(51) Int. Cl. B32B 27/00

(52) U.S. Cl. 428/500

(57) ABSTRACT

The invention relates to industrial glues, especially contact glues which are used in the foam industry, especially bi-component or multi-component glues containing polychloroprene. The object of the invention is a coagulating agent, a solution containing said agent, the use thereof in the production of a bi-compoent or multi-component glue, and the glue thus obtained. The invention also relates to a glueing method wherein said glue is used, a glued product thus obtained, and a device which is especially adapted in order to carry out said method. The coagulating agent is characterized in that it essentially comprises at least one polymer containing at least one functional acid group and at least one polymer containing at least one basic functional group.

The present invention relates to the field of industrial adhesives, more particularly that of so-called “contact” adhesives deployed in the (synthetic and rubber) foam industry, and especially those used in the manufacture of mattresses, seats, sofas, insulating complexes, technical foams, etc.

Even more specifically, the invention relates to bi-component or multi-component adhesives, in particular bi-component adhesives containing polychloroprene.

Its subject is a coagulant, a solution containing a coagulant of this type, and the use thereof for producing a bi-component or multi-component adhesive, as well as the adhesive obtained.

Its subject is also a method of adhesion using an adhesive of this type, the bonded product obtained, and a device that is particularly suitable for carrying out said method.

The use of adhesives and, more generally, of adhesive agents is common in the foam industry.

Industrial foams are generally bonded together in order to obtain the more or less complex geometric forms of the volumes to be filled. They may also be fixed on supports made from a different material, such as wood or plastics materials, for example, in the production of chairs, seats, sofas, etc. before being covered by textile or other cushion tops.

These various discrete elements must therefore be bonded together in an optimal manner to produce a system that is resistant to the normal mechanical stresses of use.

The adhesives currently used for the aforementioned purposes are generally mono-component or bi-component adhesives. In particular, polychloroprene-borne adhesive formulations have been known for a long time in this field, principally as a replacement for natural latex-borne adhesives.

The polychloroprene-borne adhesives are therefore traditionally used with a solvent-based base as a “contact” adhesive, to bond a wide range of materials, such as wood, metal, fabrics non woven fabrics, paper, plastics, such as polystyrene, PVC, and polyethylene, in particular in the field of foams and furniture (mattresses, seats, sofas, etc.).

In the specific case of solvent-based adhesives, the polychloroprene is dissolved or dispersed in a volatile solvent, most commonly chlorinated solvents or solvents with a low flash point. Because of the presence of these volatile solvents, the drying time of the contact adhesive prior to assembly is relatively quick.

However, over recent years, for reasons of safety, health or the environment, a growing demand has emerged for water-based, solvent-free products.

Organic solvent-borne adhesives potentially pose a threat to the health and safety of workers or users: irritant or noxious characteristics of certain solvents used, inflammability, dangers of build-up in poorly ventilated premises, environmental risks during production or recycling, etc.

Furthermore, it has also been noted that when they evaporated, these solvents migrated into said foams and caused softening and weakening thereof.

In the case of polychloroprene dispersed in water (polychloroprene “latex”), the water evaporates much more slowly when the polychloroprene is applied, the adhesive film not forming immediately. In many applications, however, it is necessary that assembly can start quickly after the adhesive has been applied to the support, and that the adhesive immediately develops important mechanical properties.

To obtain this almost instantaneous adhesion, one of the solutions consists in destabilising the polychloroprene “latex” during application, so as to cause instantaneous coagulation on the support and thus obtain the desired adhesion properties.

For this purpose, one of the most commonly used methods consists in destabilising a stabilised polychloroprene “latex” in an anionic manner, by adding a coagulant or a solution containing a coagulant. This solution most commonly contains an organic acid of the acetic acid, citric acid or lactic acid type, or zinc or aluminium sulphate.

However, the use of these polychloroprene “latices” has itself a certain number of drawbacks and disadvantageous limitations, in particular in the production of items of furniture of which the seats or padding are lined with synthetic or natural foams.

One of the main drawbacks is the release of hydrochloric acid (HCl) or other aggressive chlorinated substances caused by degradation of the polychloroprene chains.

Polychloroprene (2-chloro-1,3-butadiene)-based bi-component adhesives tend to release, in the region of the bonded joints or surfaces, considerable quantities of hydrochloric acid and/or corrosive chlorinated substances resulting from the decomposition of said adhesive over time and/or under the influence of certain climatic conditions (exposure to UV rays, elevated temperatures, moist air, etc.).

The emitted substances, which may also attack certain types of foams, then migrate by diffusion to the region of the fabric or materials covering the objects filled with foams of this type. In certain cases, in particular with cellulosics, this then gives rise to very distinct discoloration of said fabrics or said materials, which is all the more detrimental to the overall appearance as this discoloration is pronounced and appears in specific areas. Contact with these aggressive substances evidently has a major effect on the properties and qualities of the attacked fabrics or materials. The release of corrosive chlorinated substances may also cause an attack on metals, such as iron.

In certain particularly serious cases, the damage may be transmitted, through residual quantities of aggressive substances which accumulate on the outer surface of the products, to the clothing or skin of a user who was in prolonged contact with said products, causing the aforementioned damage and possibly resulting in allergies and irritation of the skin.

The replacement, for ecological reasons, of organic solvents with aqueous solvents has exacerbated this last problem, there being much greater relative quantities of polychloroprene present in the new, waterborne adhesives.

Furthermore, natural deterioration due to ageing of polychloroprene has proven to be greatly accelerated by the presence of oxygen and/or visible, and above all ultraviolet, light, as well as by elevated temperatures. Transparent or semi-transparent materials, such as plastic films, fabrics, etc., bonded with this type of adhesive are thus particularly sensitive.

In the majority of cases, the deterioration of the adhesive film results visually in browning and a significant loss of the mechanical properties of adhesion.

A solution aiming to eliminate this damage consists in adding antioxidants and anti UVs to the relevant formulations, so as to avoid deterioration of the polychloroprene chains. But very often this method is not sufficient, and latex manufacturers are obliged also to advocate the addition of compounds intended to stem emissions of HCl. These stemming compounds are usually metal oxide powder, such as zinc oxide or magnesium oxide. The main disadvantage of this method is that these powders tend to form agglomerates in water, which can cause, on the one hand, the spray nozzles to become blocked and, on the other hand, the oxide to be distributed inhomogeneously in the adhesive film, leaving certain zones unprotected. A further major disadvantage is that these oxides, because of their densities, tend to deposit sediment during storage of the aqueous solutions containing them.

The problem posed to the present invention consists in overcoming certain, if not all, of the aforementioned drawbacks, and in proposing a means to allow adhesives for industrial foams to be made as effective as the other adhesives that have commonly been used in the past, while at the same time allowing an aqueous solvent to be brought into general use, and the production of noxious substances connected to the natural and/or induced decomposition of said adhesives to be reduced or eliminated as far as possible.

For this purpose, the main subject of the present invention is a coagulant for bi-component or multi-component adhesives having at least one first, coagulating component and one second, adhesive component, characterised in that it substantially comprises at least one polymer possessing at least one acid functional group and at least one polymer possessing at least one basic functional group.

The introduction of a coagulant of this type allows the majority, if not all, of the noxious substances produced by the decomposition of the adhesive component to be absorbed and retained in the adhesive films, where they are neutralised or kept captured.

A further subject of the present invention is a solution containing a coagulant, the use of a coagulant of this type or of a solution of this type to obtain a bi-component or multi-component adhesive, and an adhesive comprising at least one coagulant of this type or at least one solution containing a coagulant of this type.

A further subject of the present invention is a method of adhesion, characterised in that it consists in combining by co-spraying the coagulating component and adhesive component of a bi-component adhesive according to the invention, in order to obtain a totally homogeneous adhesive film disposed on at least one of the two parts or faces of the elements to be bonded together, then in bringing said adhesive-coated parts or face(s) into contact, it being possible to obtain the bonded product by said method, and a device for carrying out said method according to the invention.

This device is characterised in that it is made in the form of a gun having a first and a second coaxial or substantially coaxial nozzle, the first nozzle being connected to a reservoir containing the first, coagulating component and the second nozzle being connected to a reservoir containing the second, adhesive component.

A better understanding of the invention will be facilitated by the following description, which relates to a preferred embodiment, given by way of a non-limiting example.

The subject of the present invention is therefore a coagulant for bi-component or multi-component adhesives having at least one first, coagulating component and one second, adhesive component, characterised in that it substantially comprises at least one polymer possessing at least one acid functional group and at least one polymer possessing at least one basic functional group.

The term “polymer” refers to macromolecules formed by joining much smaller molecules called “monomers” to form chains. When the chain only comprises a few monomers, the term “oligomer” is sometimes used instead of polymer. But there is neither an absolute rule, nor a fixed number of monomer units, fewer than which would constitute an oligomer, and more than which would constitute a polymer. For this reason, the present description will hereinafter use the term polymer to describe any chain comprising more than two monomer units. The term polymer, as it is used in the present invention, includes both homopolymers, formed by the repetition of an identical monomer, and copolymers, which are formed by a sequence of different monomers.

Conventionally, said polymers may also have (crosslinked) bridges inter se, grafted groups, etc.

The inventors have surprisingly and unexpectedly found that polymers comprising, on the one hand, a basic group capable of undergoing protonation and, on the other hand, an acid group allowing, when they are added to the coagulant, the release of noxious substances, for example of chlorinated substances, such as gaseous HCl, to be collected, and that they thus allow greater protection of the materials in direct contact with the adhesive, but also of the surrounding materials, which may be in contact with said substances.

According to a particular embodiment, the coagulant according to the invention is characterised in that it comprises at least one polymer possessing both at least one acid functional group and at least one basic functional group.

It has surprisingly been found that the particular acid-collecting properties could be observed equally clearly when the acid functions and the basic functions were present in a single polymer (amphoteric polymer) as when there was a mixture of polymers carrying acid functions and polymers carrying basic functions, or even in the case of any mixture of at least two of the aforementioned polymers.

According to a further characteristic of the invention, the coagulant is characterised in that at least one acid functional group is a carboxyl group.

According to a further characteristic, at least one basic functional group comprises at least one nitrogen atom.

Preferably, at least one basic functional group is an amino group. The coagulant according to the invention is also characterised in that at least one basic functional group is selected from the group formed by: 2-vinylpyridine, 4-vinylpyridine, beta-aminoethyl (meth)acrylate, t-butylaminoethyl (meth)acrylate, methylaminoethyl (meth)acrylate, and also dimethylaminoethyl (meth)acrylate, N-monomethylaminoethyl(meth)acrylamide, dimethylaminopropyl-(meth)acrylamide and mixtures thereof.

It has been found that if the acid functions are carboxylic acid functions, and the basic functions are amino groups, the polymer or mixture of polymers is particularly advantageous, especially in terms of protection.

The polymers containing these functions may be of different families, but those synthesised by radical polymerisation of acrylic or methacrylic functional monomers will be preferred, owing to the fact that a person skilled in the art will have considerable expertise in this method of polymerisation, to the availability of numerous corresponding monomers, and to their reasonable cost. Compounds of this type are, for example, available under the trade mark ENOREX of Collano AG CH-6203 Sempach-Station.

A more general description is given below of the polymers or monomers intended for the synthesis of polymers according to the invention.

A further advantage of the use of these polymers instead of metal oxides is that the intrinsic properties of these polymers allow the adhesive and mechanical properties of the adhesion to be modified. It is obvious to a person skilled in the art that the addition of various polymers (through the coagulant) to the adhesive component, for example a component containing polychloroprene, may modify the final characteristics of the adhesive film, such as, for example, the initial glue, the tack, the elasticity, the cohesion of the film, the adhesion of the film on the support, the mechanical tensile strength, the temperature resistance, etc.

The functionalised (co)polymer or polymers entering the composition of the coagulant may be obtained by known methods of radical polymerisation of ethylenically unsaturated monomers. On this subject, see in particular the book “Polymerisation: principles and applications” by G. Odian (translated into French by E. Franta).

To obtain polymers of this type, an advantageous method consists in polymerising:

at least one ethylenically unsaturated monomer (a), possessing a group capable of undergoing protonation in the application medium,

at least one ethylenically unsaturated monomer (b), carrying an acid function and capable of ionising negatively in the application medium, and optionally at least one neutral monomer (c), which may be copolymerised with at least one of the aforementioned monomers.

To obtain an amphoteric polymer, polymerisation will concern either copolymerisation of at least one monomer (a) and at least one monomer (b) and at least one monomer (c), or copolymerisation of at least one monomer (a) and at least one monomer (b).

To obtain a polymer with an anionic character, the polymerisation will concern either the copolymerisation of at least one monomer (b) and at least one monomer (c), or the polymerisation of at least one monomer (b).

To obtain a polymer with a cationic character, the polymerisation will concern the copolymerisation of at least one monomer (a) and at least one monomer (c), or the polymerisation of at least one monomer (a).

Radical polymerisation is preferably conducted in an inert environment without oxygen. The polymerisation may be carried out in a mass or in a solvent medium. Preferably, an inert solvent, such as methanol, ethanol, water, or a mixture thereof, will be used. Polymerisation will preferably be conducted in water.

Polymerisation is initiated by adding a polymerisation initiator, which is a generator of free radicals. Examples of compounds of this type used in the technique include organic peresters (t-butylperoxypivalate, t-amylperoxypivalate, etc.), azo-type compounds (azo-bis isobutyronitrile, azo-bis 2,4 dimethylvaleronitrile, azo-bis cyclohexane carbonitrile, azo-bis amidinopropane hydrochloride, etc.), inorganic and organic peroxides (for example, hydrogen peroxide, benzyl peroxide, t-butyl hydroperoxide, cumyl hydroperoxide, etc.), so-called “redox” initiator systems, for example those comprising oxidising agents (such as the (ammonium or alkali metal) persulphates, chlorates, bromates, peroxides, hydroperoxides), reducing agents (such as, for example, sulphites or bisulphites (including products which react with organic products, such as aldehydes or ketones)), oxalic acid, ascorbic acid, glucose, as well as the mixtures of two or more of these compounds. The redox initiators may advantageously be catalysed by metal ions possessing a plurality of oxidation levels (for example, Fe, Cu, Ti, Cr, Ni, Co, Zn, etc.).

The preferred initiators are initiators that are partially or entirely soluble in water. Preferably, totally soluble initiators will be selected, such as sodium persulphate, potassium persulphate, azo-bis-amidinopropane hydrochloride, and the potassium persulphate/sodium bisulphite redox system.

In a variant, photochemical initiators may be produced using systems generating free radicals by ultraviolet (UV) or visible irradiation. These compounds contain, for example, ketone groups such as benzophenone and acetophenone. Other products, such as benzoin, the ethers derived from benzoin, benzyl and the acetals of benzyl, are known and used in the photochemical initiating technique.

The quantity of initiator used is in general a quantity required to initiate the polymerisation and obtain complete conversion of the unsaturated monomer or monomers over a reasonable time, as judged by a person skilled in the art.

Preferably, the initiators are present in a proportion ranging from 0.01% to 10% by weight in relation to the total weight of the monomers, a preferred proportion being in a range from 0.1 to 4%.

The initiator may be added, entirely or in part, at the start of or during polymerisation, in a continuous or discontinuous manner.

Polymerisation is carried out under reaction conditions that are known by a person skilled in the art. All or a portion of the monomers may be added at the start, then during polymerisation, in a discontinuous or continuous manner. A preferred manner is the “semi-batch” technique. Preferably, polymerisation is conducted at a temperature ranging from about 20° C. to 120° C. (for a reaction in an autoclave), and more preferably from 50° C. to 90° C.

Advantageously, for the synthesis of the polymers containing basic functions, a method consists in (co)polymerising monomers having, on the one hand, ethylene unsaturation and, on the other hand, an amino group capable of undergoing protonation.

It is possible to use the following monomers as monomers (a) comprising amino groups:

a) aminoalkyl vinyl ethers

Examples that may be cited include beta-aminoethylvinylether, N-monomethyl-beta-aminoethylvinylether, N-monobutyl-beta-aminoethylvinylether, N-monomethyl-3-aminopropylvinylether, and combinations thereof.

b) aromatic vinyl compounds

Examples that may be cited include 2-vinylpyridine, 4-vinylpyridine, 2-ethyl-5-vinylpyridine, and mixtures thereof.

c) esters derived from (meth)acrylates or (meth)acrylamide, such as those represented by the following formula I:

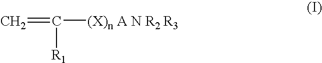

in which

R₁ is H or methyl

X is O or N(H)

n is equal to 0 or 1

if n=0, then A is O (CH₂)ₓ, where x=2 or 3

if n=1, then A is CₙH₂ₙ, with n varying from 2 to 4

R₂ is H, methyl, ethyl,

R₃ is H, phenyl, benzyl, cyclohexyl, linear or branched alkyl in C₁-C₆

Examples of preferred monomers of formula I that may be cited include: beta-aminoehtyl (meth)acrylate, t-butylaminoethyl (meth)acrylate, dipropylaminoethyl (meth)acrylate, methylaminoethyl (meth)acrylate, and also N-methyl-N-hydroxyethylaminoethyl (meth)acrylate, N-(mono-n-butyl)-4-aminobutyl (meth)acrylate, methacryloxyethoxyethylamine and mixtures thereof, and more preferably dimethylaminoethyl (meth)acrylate.

Further examples of preferred monomers that may be cited include N-beta-aminoethyl (meth)acrylamide, N-monomethylaminoethyl (meth)acrylamide, dimethylaminopropyl (meth)acrylamide and mixtures thereof.

d) vinylamine derivatives

The derivatives such as vinylpformamide or vinylacetamide result after polymerisation in polymers that are capable of being hydrolysed, giving rise to polyvinylamines.

e) others

Other monomers capable of undergoing protonation that may be used are N-acryloxylalkyl-oxazolidines and N-acryloxyalkyltetrahydro-1,3-oxazines and mixtures thereof.

These compounds have the following formula II:

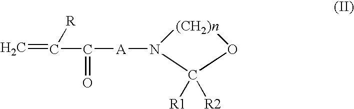

in which

R is H or CH₃,

n=2 or 3,

A is O (CH₂)ₙ or (O alkylene)ₘ having an average molar mass between 88 g and 348 g, and where the alkylene groups are ethylene and/or propylene,

R₁, R₂ may be H, an aryl group or an alkyl group.

The compounds of formula II are described in patents U.S. Pat. No. 3,037,006 and U.S. Pat. No. 3,502,627. These compounds may hydrolyse to give secondary amines having the structure given in the following formula III:

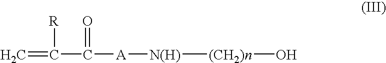

It may be useful to synthesise polymers from monomers possessing a blocked amine function that is capable of being subsequently hydrolysed, such as the acryloxy-ketimines or the acryloxyaldimines, in which the amine is conjugated to a carbon atom by an unsaturated bond N═C. In the appropriate conditions, the hydrolysis of this bond releases a primary amine.

monomer (b)

For the synthesis of (co)polymers comprising an acid function, it will be advantageous to select the monomers from the ethylenically unsaturated C₃-C₈ carboxylic, sulphonic, sulphuric, phosphonic and phosphoric acids.

Preferably, the acid monomer is selected from acrylic acid, methacrylic acid, alpha-ethacrylic acid, beta-carboxyethylacrylate acid, methylenemalonic acid, vinylacetic acid, allylacetic acid, crotonic acid, maleic acid, fumaric acid, itaconic acid, monomethyl itaconate, monomethyl fumarate, monobutyl fumarate, maleic anhydride, mesaconic acid, N-methacrylo-alanine, N-acryloylhydroxy-glycine, sulpfopropyl acrylate, sulpfoethyl acrylate, sulpfoethyl methacrylate, 2-acrylamido-2-methylpropanesulphonic acid, styrenesulphonic acid, vinylsulphonic acid, vinylphosphonic acid, phosphoethyl acrylate, phosphonethyl acrylate, phosphopropyl acrylate, phosphonopropyl acrylate, phosphoethyl methacrylate, phosphonoethyl methacrylate, phosophopropyl methacrylate, phosphonopropyl methacrylate, alkali metal salts and ammonium salts thereof.

neutral monomer (c)

A small proportion of relatively hydrophobic monomer may also be used to make the water-soluble polymer. There is a wide range of neutral ethylenically unsaturated monomers, which are capable of being copolymerised to obtain the claimed polymers.

A preferred choice is the family of the (meth)acrylates. The term “(meth)acrylates” is taken to mean monomers derived from acrylic acid and/or methacrylate acid. This includes the esters or the amides of these compounds, as well as their derivatives. These will preferably be (meth)acrylate esters, acrylamide esters and methacrylamide esters possessing a lateral alkyl chain in C₁-C₁₂ and mixtures thereof. Preferably, for example, methyl, ethyl, n-butyl, t-butyl, 2-ethylhexyl, decyl or isobornyl acrylate, methyl, ethyl, n-propyl, isopropyl, n-butyl, isobutyl, sec-butyl, cyclohexyl, isodecyl, isobornyl, t-butyl, stearyl, glycidyl, dicyclopentenyl or phenyl methacrylate will be selected.

It may also be advantageous to select neutral monomers from vinyl esters, such as the vinyl versatates, vinyl laurate or vinyl stearate.

It may also be advantageous to select neutral monomers from the aromatic vinyl monomers, such as styrene, p-methylstyrene, o-methylstyrene, o,p-dimethylstyrene, o,p-diethylstyrene, p-chlorostyrene, isopropylstyrene, t-butylstyrene, o-methyl-p-isopropylstyrene, o,p-dichlorostyrene and mixtures thereof. The preferred aromatic vinyl monomers are styrene and vinyltoluene, in particular because of their availability and their low costs, and, more preferably, styrene.

More water-soluble unsaturated neutral monomers may also be used, such as, for example, vinyl acetate, hydroxyethyl (meth)acrylate, ethylene glycol mono and di (meth)acrylates and propyleneglycol mono and di (meth)acrylates, methoxyethyl (meth)acrylate, ethoxyethyl (meth)acrylate, methoxypropyl (meth)acrylate, ethoxypropyl (meth)acrylate, butoxyethyl (meth)acrylate and mixtures thereof.

When it is desired to control the molar mass of the polymers obtained, it is possible to use chain transfer agents, preferably methyl tetrachloride and methyl tetrabromide and the mercaptans, such as, for example, ethyl mercaptan, butyl mercaptan, n-dodecyl-mercaptan, octyl-mercaptan, isooctyl-mercaptan, thioglycolic acid and the derived (butyl, isoctyl, dodecyl) esters thereof, amino-2-ethylmercaptan and thioethanol.

According to a further embodiment, it is also possible to use a mixture of polymers comprising a polyimine (or polyiminoalkylene) as the basic component. Polyimines are polymers produced by polymerisation of monomers which do not have ethylene unsaturation C═C, but which either have carbon-nitrogen unsaturation or form a cyclic compound. After polymerisation, the polyimines have nitrogen atoms included in the chain of the polymer. These atoms may undergo protonation (in the presence of HCl, for example) in the same way as “pending” amino groups.

Certain cyclic ethers of the endo-imine type (formula IV) may polymerise by cationic means and give a poly (N-acylalkyleneimine), which, after hydrolysis, gives rise to a polyalkyleneimine.

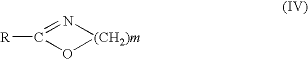

where m=2 or 3, R=phenyl, benzyl, or a C₁-C₁₂ alkyl group.

The most common monomers are the two oxazolidines, substituted in the 2 position (m=2), or the 5,6-dihydro-4H-1,3-oxazines (m=3) substituted in the 2 position.

The polyimines which may be suitable as polymers comprising a basic function are the polyethyleneimines or the polypropyleneimines, in particular those which are available from BASF under the name POLYMIN (registered trade mark).

According to a further characteristic of the invention, the ratio R between the number of acid functional groups and the number of basic functional groups present in the polymer or polymers is between 1:80 and 1:1.

Preferably, the ratio R is between 1:20 and 1:7.

According to a further characteristic, the coagulant according to the invention contains at least one polymer having at least one (meth)acrylic monomer, provided with at least one acid function. Advantageously, it contains at least one polymer, of which at least one of the monomers is selected from the group formed by fumaric acid, maleic acid, itaconic acid, maleic anhydride, monomethyl fumarate and monobutyl fumarate.

According to a further preferred characteristic, the coagulant according to the invention is characterised in that it contains at least one polymer, of which at least one of the monomers is an acrylate, a methacrylate, an acrylamide or a methacrylamide, and comprising an amine capable of undergoing protonation.

Preferably, the coagulant according to the invention is characterised in that the average molar mass of the polymer or polymers possessing the acid and/or basic group or groups is less than 1,000,000 grammes, preferably less than 500,000 grammes, and more preferably between 500 and 500,000 grammes.

Unless otherwise indicated, all references to the molar mass of a polymer or of a mixture of polymers shall be taken to mean the average molar mass by weight (by mass), expressed in grammes. The molar mass may be established in several way, such as, for example, by gel permeation chromatography (GPC), by viscosimetry, or by so-called “MALDI-TOF” time-of-flight mass spectrometry.

A further subject of the present invention is a solution containing a coagulant according to the invention.

According to an advantageous characteristic, the solvent of the polymer or polymers is substantially water. The coagulation agent or coagulant is preferably made in the form of an aqueous polymer solution. By “aqueous solution”, it is meant that the solvent is substantially water. The presence of a small quantity (max. 5% by weight) of organic solvent that is soluble in water and is capable of allowing the polymer to be placed in solution, of promoting the coagulation of the adhesive component, or of improving the wettability of the bonded surfaces is not, however, excluded.

It is also possible to find residual traces of organic solvents stemming from the constituents of the coagulant. Solutions using only water are, however, preferred.

All risks of irritation and/or toxicity faced by the users and the environment are thus limited or avoided, and the inflammable nature of the solution used is also limited as much as possible.

To obtain the stability performance of the adhesive film, as well as satisfactory coagulation of an adhesive component formed, for example, substantially from polychloroprene, the solution according to the present invention is characterised in that the basic functional group content is greater than 0.1 mol/litre.

The coagulant solution according to the invention is also characterised in that the content of polymer(s) possessing one or more acid and/or basic groups is between 0.1% and 45% by weight.

Preferably, in said solution the content of polymer(s) possessing one or more acid and/or basic groups is between 0.2% and 15% by weight.

According to a further characteristic, the solution according to the invention is characterised in that its pH is less than 7, preferably less than 5. The bi-component or multi-component system results in effective coagulation when the coagulant has an acidic pH value, i.e. less than 7, and preferably, for optimal coagulation, less than 5.

The polymer or polymers contained in the coagulant have amphoteric properties, which may mean that the pH needs to be adjusted. Weak acids or acid metal salts, which are commonly used as coagulants, may be added to adjust the pH value.

The coagulating solution according to the invention is thus also characterised in that it also comprises at least one weak acid, preferably an organic weak acid.

Advantageously, the weak acid or acids are selected from the group formed by formic acid, acetic acid, propanoic acid, butanoic acid, lactic acid, tartaric acid, ascorbic acid, phosphoric acid and glycolic acid.

It is also possible to use one or more acid metal salt in conjunction with, or as a replacement for, one or more of the aforementioned acids.

According to a variant, the solution according to the invention is thus characterised in that it also comprises at least one acid metal salt.

In a particularly advantageous manner, the acid metal salt or salts is/are selected from zinc sulphate or aluminium sulphate.

The use of these salts generally has the advantage that it does not result in an attack, and therefore a deterioration, of parts that are present in the spraying equipment, and that would be sensitive to contact with organic acids. The addition of salts such as calcium chloride or sodium chloride, may also result in an increase in the ionic strength, and might also contribute to destabilisation of the adhesive component.

The viscosity of the coagulant is set so as to obtain a solution which is perfectly sprayable with standard spraying equipment.

According to a further characteristic of the invention, the solution containing the coagulant is characterised in that it has a viscosity between 0.9 mPa.s and 10,000 mPa.s, preferably less than 500 mPa.s, such that it can be applied by spraying.

The viscosity depends mainly on the type of the polymer or polymers formulated in the coagulant, their molecular weights and their concentrations.

A further subject of the present invention is the use of a coagulant or of a solution according to the invention to obtain a bi-component or multi-component adhesive, and also the bi-component or multi-component adhesive comprising at least one coagulant or at least one solution containing a coagulant according to the invention.

According to a particularly preferred embodiment, the adhesive according to the invention is characterised in that it is a bi-component adhesive, the coagulant or the solution containing a coagulant according to the invention forming the first, coagulating component, the second component being the adhesive component.

In an even more preferred manner, the adhesive according to the invention is characterised in that the second, adhesive component contains polychloroprene or poly(2-chloro-1,3-butadiene) capable of coagulating by reduction of the pH.

The coagulant is thus used in the presence of at least one adhesive component, which it is capable of destabilising. This adhesive component contains polychloroprene in aqueous dispersion. The polychloroprene refers to a homopolymer or to a chloroprene (2-chloro-1,3-butadiene) copolymer, optionally polymerised in the presence of co-ethylenically unsaturated monomers, such as styrene or acrylates.

The dispersions of polychloroprenes that are available on the market and are capable of being used in the present invention are generally anionic dispersions, i.e. dispersions that are stabilised with the aid of anionic surfactants, optionally combined with non-ionic surfactants. Preferably, anionic dispersions, which will coagulate if the pH decreases, will be used.

Besides the polychloroprene in dispersion, the adhesive component may contain other polymer dispersions, resins in dispersions and additives according to the usual standard formulations of the prior art. Reference may also be made to the compositions described in the technical specifications of suppliers of polychloroprene in dispersion, such as Enichem, Du Pont de Nemours, Dow Elastomers, Bayer, etc.

Preferably, the adhesive component contains protective agents, such as antioxidants and anti UVs, such as those offered by Ciba Specialities and sold under the names Irganox and Tinuvin, or Wingstay L by Goodyear. Preferably, for better incorporation during formulation, liquid-form or predispersed-form products will be used.

Generally, for its use in the coagulant, the aqueous phase containing the polymer or the polymer mixtures must be homogeneous, so that the polymer distribution in the final adhesion will also be as homogeneous as possible.

The term “water-soluble” shall refer to a polymer or mixture of polymers which forms a homogeneous solution in water. Polymers may be entirely soluble in acid, basic or neutral form. While certain polymers are soluble over the entire pH range, others are soluble, for example, between pH 2 and 10. Certain polymers, mostly containing an amino, for example, may be insoluble at a high pH, but soluble or partially soluble at lower pHs, as is the case with coagulating solutions that have a pH lower than 7.

The term “partially soluble” shall be used when the polymer does not form a real solution, but when a portion of the macromolecule is soluble, or when the macromolecules are dissolved in the form of micelles or aggregates (in the case of aggregates, the macromolecules are inflated in large proportions by the water), without, however, there being two distinct phases in the solution. Partially soluble polymers form what are called “colloidal” solutions.

The term “water-soluble” shall encompass both polymers that are perfectly soluble and those that are partially soluble (real solution and colloidal solution).

Materials are joined with the aid of systems according to the invention, comprising at least one adhesive component and at least one coagulating component containing an acid stemming compound, by applying the intimate mixture of these components on at least one of the faces to be joined.

The quantity of adhesive required is generally between 30 and 300 moist g/m² and preferably between 50 and 200 moist g/m². An adhesive film is thus obtained on the coated surface or surfaces, allowing the parts to be joined to be brought into contact almost instantaneously. It is, however, desirable that one of the two surfaces possesses a certain porosity, in order to allow water to be eliminated from the adhesive joint. In industrial applications, the materials are joined quickly after coating of the adhesive film, often in less than a minute, but the tack range may easily be extended to 30 minutes if so desired.

The aforementioned type of adhesion is preferably used for joining foams on various supports, such as foam/foam, foam/wood, foam/plastic, etc. in the mattress, seat, textile, furniture, etc. industry.

A further subject of the present invention is a method of adhesion, characterised in that it consists in combining by co-spraying the coagulating component and adhesive component of a bi-component adhesive according to the invention, in order to obtain a totally homogeneous adhesive film disposed on at least one of the two parts or faces of the elements to be bonded together, then in bringing said adhesive-coated parts or face(s) into contact.

A further subject of the present invention is the bonded product that may obtained by the method, and that differs from known products, in particular by its strengthened mechanical and chemical properties.

Finally, a further subject of the present invention is a device for carrying out the aforementioned method, characterised in that it is made in the form of a gun having a first and a second coaxial or substantially coaxial nozzle, the first nozzle being connected to a reservoir containing the first, coagulating component and the second nozzle being connected to a reservoir containing the second, adhesive component.

Materials are thus bonded with the aid of the bi-component adhesive of the present invention and preferably with the aid of a spraying apparatus. This apparatus comprises, in particular, tanks for storing the two components, connected by a system allowing the conveyance of fluids to a part producing the intimate mixture of the two components. This system is preferably a spray gun allowing simultaneous spraying of the adhesive component and the coagulating component. The mixture is then produced in the spray mist. The guns that are preferably used have a first and a second coaxial or substantially coaxial nozzle, the first nozzle being connected to a reservoir containing the first, coagulating component and the second nozzle being connected to a reservoir containing the second, adhesive component.

The ratio of adhesive/coagulant spray outputs is preferably between 10/1 and 1/1, and preferably equal or close to 10/3. This ratio may be adjusted, for example, with the aid of metering pumps or alternatively by controlling the pressure in the tanks containing the two components. The adhesion equipment may have a single station or multiple stations.

A preferred and particularly suitable range of adhesion equipment is, for example, that offered by the applicant CHIMISTRA (F-67520 Marlenheim) and sold under the name AQUA-SYSTEM (registered trade mark).

A controlled UV irradiation test was designed to display the stability of the adhesive film obtained according to the invention in comparison with standard aqueous or solvent-based formulations. This test allows the release of hydrochloric acid to be fixed during the time when the adhesive film is subjected to strong UV irradiation, corresponding to exposure to solar rays through a pane of glass.

The adhesive film of the present test is prepared by applying the formulations by spraying on a sheet of glass for a moist GSM of approx. 180 g/m². Once it has completely dried, the adhesive film is covered with a piece of furniture fabric that is typically used for manufacturing a sofa.

The same roll of green-coloured furniture fabric, displaying yellowish discoloration in the presence of hydrochloric acid, was used for all of the experiments.

A strip of (Congo red) pH indicator paper, that is sensitive to releases of acid, was placed above the piece of fabric. The glass/adhesive/fabric specimens of a series of adhesives to be tested were placed at the same time in a standard test apparatus known by the name Q-UV (Q-panel Lab. Products Bolton) and provided with 40 watt UV (340 nm) lamps.

After a certain time, the temperature in the irradiation chamber reached, and was maintained at, 60° C. The specimens were checked regularly over the time, and three visual parameters were noted, namely:

the variation of the colour of the indicator paper,

the coloration of the adhesive film, and

the deterioration of the fabric.

The strength characteristiques of the adhesive films were examined according to the number of hours of UV irradiation, and were compared.

The adhesion performance of the bi-component adhesive according to the invention is assessed by a so-called “pinch-bonded” test. The 60 mm×120 mm surface of a block of polyurethane foam, measuring 60 mm×120 mm×120 mm and having a density of approx. 40 kg/m³, is bonded by spraying of the adhesive to be tested at a GSM rate of 100 g/m² and 130 g/m². The bonded surface is immediately brought into contact with itself by performing a manual pinch, so as to obtain a fold in the middle along the length of the 120 mm. This produces strong tension on the adhesive joint, and the performance of the adhesive to be tested is assessed according to whether the joint stays perfectly closed or whether there is disbanding in the region of the contact. The performance, with respect to the contactability of the bonded to be tested, is judged to be good if the joint remains closed, for one of the two GSMs, one hour after joining, and very good if the joint remains closed for both GSMs indicated.

Unless otherwise indicated, all the percentages indicated are values in dry weight. All of the spraying operations were carried out using the Aquasystem 21/22 apparatus supplied by Chimistra S.A.

Test A

The following compares the stability to UV rays of films with a formulation of polychloroprene in dispersion, sprayed without a coagulant, with the same formulation sprayed in the presence of a standard coagulant, and with the same formulation sprayed in the presence of a coagulant according to the invention. The object of this example is to display the beneficial influence of a solubilised, functionalised copolymer in the coagulant.

The dispersion of polychloroprene used as an adhesive component is a standard dispersion for this application, such as Dispercol C84 by Bayer, in which protective additives Irganox 1520D and Tinuvin 213 are added, both at a rate of 1%.

The standard coagulant is an aqueous solution with 20% zinc sulphate.

The coagulant (or coagulating agent) according to the invention used for the following tests comprises an acrylic acid and diaminoethylmethacrylate-based copolymer, sold by the applicant under the name ENOREX VN 230 (registered trade mark). The coagulant was implemented in the form of an aqueous solution with 4.5% by weight of copolymer, a solution of which the pH was adjusted to 4 by adding ascorbic acid. The results are presented in the following Table 1:

TABLE 1

| | | | Adhesive |
|---|---|---|---|
| | | | film |
| | (Congo red) | Fabric | appearance |
| | indicator paper | (presence of | after 100 |
| Coagulant | turning blue | discoloration) | hours |
| None | after 24 hours | after 40 hours | brown |
| (reference) | | | |
| Zn sulphate | after 24 hours | after 40 hours | brown |
| solution | | | |
| Solution | after 100 hours | after 110 hours | yellow |
| according to | | | |
| the invention | | | |
| (Enorex VN 230 + | | | |
| ascorbic acid) | | | |

It should be noted that the stability to UV rays is better in the case of the bi-component adhesive system introducing the functionalised, water-soluble polymer in a coagulant according to the present invention. It should also be noted that the adhesive film, which initially has a whitish colour, only turns slightly yellow after 100 hours with the coagulation solution according to the invention.

Test B

This test allows verification of the stability to UV rays and the adhesive performance (according to the pinch-bonded test) in the case of solutions comprising at least one coagulant according to the invention, of which the pH is reduced below 5 with the aid of various types of acidifiers.

The results given in Table 2 (below) were compared with those obtained when the adhesive was sprayed without a coagulant, and when it was sprayed with a standard coagulant, i.e. a 20% aluminium sulphate solution. The adhesive component was the same as that of example A.

The functionalised polymer contained in the coagulation solution of this test was the same as that cited in test A, and was solubilised at a rate of two different concentrations. All of the tests were carried out at an adhesive component/coagulant ratio (in moist weight) of 10/3.

TABLE 2

| | Polymer | | Yellowing of |
|---|---|---|---|
| | concentration | Pinch- | the adhesive |
| Coagulant | (%) | bonded | film after |
| None | — | bad | 30 hours |
| (reference) | | | |
| Enorex VN 230 + lactic | 1.2 | good | 40 hours |
| acid | 4.5 | very good | 40 hours |
| Enorex VN 230 + ascorbic | 1.2 | good | 40 hours |
| acid | 4.5 | very good | 40 hours |
| Enorex VN 230 + aluminium | 1.2 | very good | 30 hours |
| sulphate | 4.5 | very good | 30 hours |
| Aluminium | — | very good | 18 hours |
| sulphate | | very good | 18 hours |

Test C

Solvent-borne adhesives are to date still largely used in the field of adhesion of foams, in particular in furniture. In the replacement of solvent-based systems by aqueous systems, this example compares the resistance to UV rays of polychloroprene contact adhesive in the solvent phase and polychloroprene contact adhesive in the aqueous phase according to the invention.

As a reference test, a 10% Butaclor MA 434 polychloroprene (made by EniChem Elastomeres France) solution in toluene was prepared in a laboratory and sprayed on a sheet of glass, in order to obtain a polychloroprene deposit equivalent to that obtained in the case of the bi-component aqueous adhesive according to the invention.

A standard solvent-based polychloroprene contact adhesive, containing approx. 15% polychloroprene, was also studied. It should be noted that, in the case of an aqueous dispersion, the polychloroprene solid content was much higher, and could reach 50%.

The composition of the aqueous formulation of adhesive according to the invention is as follows:

| | | |
|---|---|---|
| Adhesive component | Dispercoll C84 | 100 parts |
| | Irganox 1520 D | 1 part |
| | Tinuvin 213 | 1 part |
| Coagulating | Enorex VN 230 | 4 parts |
| component | Lactic acid | enough for pH = 3 |
| | Water | 96 parts |
| Adhesive/coagulant | 10/3 | |
| ratio | | |

The results presented in Table 3 show that a standard solvent-based polychloroprene adhesive subjected to a controlled UV test results in known phenomena of deterioration, but with less intensity.

The resistance to UV in the case of the bi-component adhesive according to the invention is greatly increased.

TABLE 3

| | Colour of the | | |
|---|---|---|---|
| | (Congo red) | | |
| | indicator | | Yellowing of |
| | paper after n | Discoloration | the adhesive |
| Adhesive | hours | of the textile | film |
| Polychloroprene | blue after 8 | after 8 hours | after 15 hours |
| solution in | hours | | |
| toluene | | | |
| (reference) | | | |
| Standard | violet after | after 40 hours | after 24 hours |
| polychloroprene | 18 hours | | |
| solvent-based | | | |
| adhesive | | | |
| Aqueous | blue after | after 100 | after 100 |
| adhesive | 100 hours | hours | hours |
| formulation | | | |
| according to | | | |
| the invention | | | |

The invention is not of course limited to the embodiments described. Modifications are possible, in particular with regard to the constitution of various elements or by substitution of technical equivalents, without thereby departing from the scope of protection of the invention.

1. Coagulant for bi-component or multi-component adhesives having at least one first coagulating component and one second adhesive component, characterised in that it substantially comprises at least one polymer possessing at least one acid functional group and at least one polymer possessing at least one basic functional group.

2. Agent according to claim 1, characterised in that it comprises at least one polymer possessing both at least one acid functional group and at least one basic functional group.

3. Agent according to claim 1 or 2, characterised in that at least one acid functional group is a carboxyl group.

4. Agent according to any of claims 1 to 3, characterised in that at least one basic functional group comprises at least one nitrogen atom.

5. Agent according to claim 4, characterised in that at least one basic functional group is an amino group.

6. Agent according to claim 4 or 5, characterised in that at least one basic functional group is selected from the group formed by: 2-vinylpyridine, 4-vinylpyridine, beta-aminoethyl (meth)acrylate, t-butylaminoethyl (meth)acrylate, methylaminoethyl (meth)acrylate, and also dimethylaminoethyl (meth)acrylate, N-monomethylaminoethyl(meth)acrylamide, dimethylaminopropyl(meth)acrylamide and mixtures thereof.

7. Agent according any of claims 1 to 6, characterised in that the ratio R between the number of acid functional groups and the number of basic functional groups present in the polymer or polymers is between 1:80 and 1:1.

8. Agent according to claim 7, characterised in that the ratio R is between 1:20 and 1:7.

9. Agent according to any of claims 1 to 8, characterised in that it contains at least one polymer having at least one (meth)acrylic monomer, provided with at least one acid function.

10. Agent according to any of claims 1 to 9, characterised in that it contains at least one polymer, of which at least one of the monomers is selected from the group formed by fumaric acid, maleic acid, itaconic acid, maleic anhydride, monomethyl fumarate and monobutyl fumarate.

11. Agent according to any of claims 1 to 10, characterised in that it contains at least one polymer, of which at least one of the monomers is an acrylate, a methacrylate, an acrylamide or a methacrylamide, and comprising an amine capable of undergoing protonation.

12. Agent according to any of claims 1 to 11, characterised in that the average molar mass of the polymer or polymers possessing the acid and/or basic group or groups is less than 1,000,000 grammes, preferably less than 500,000 grammes, and more preferably between 500 and 500,000 grammes.

13. Solution containing a coagulant according to any of claims 1 to 12.

14. Solution according to claim 13, characterised in that the solvent of the polymer or polymers is substantially water.

15. Solution according to claim 13 or 4, characterised in that the basic functional group content is greater than 0.1 mol/litre.

16. Solution according to any of claims 13 to 15, characterised in that the content of polymer(s) possessing one or more acid and/or basic groups is between 0.1% and 45% by weight.

17. Solution according to claim 16, characterised in that the content of polymer(s) possessing one or more acid and/or basic groups is between 0.2% and 15% by weight.

18. Solution according to any one of claims 13 to 17, characterised in that its pH is less than 7, preferably less than 5.

19. Solution according to claim 18, characterised in that it also comprises at least one weak acid, preferably an organic weak acid.

20. Solution according to claim 19, characterised in that the weak acid or acids are selected from the group formed by formic acid, acetic acid, propanoic acid, butanoic acid, lactic acid, tartaric acid, ascorbic acid, phosphoric acid and glycolic acid.

21. Solution according to any of claims 18 to 20, characterised in that it also comprises at least one acid metal salt.

22. Solution according to claim 21, characterised in that the acid metal salt or salts is/are selected from zinc sulphate or aluminium sulphate.

23. Solution according to any of claims 13 to 22, characterised in that it has a viscosity between 0.9 mPa.s and 10,000 mPa.s, preferably less than 500 mPa.s, such that it can be applied by spraying.

24. Use of a coagulant according to any of claims 1 to 12 or of a solution according to any of claims 13 to 23 to obtain a bi-component or multi-component adhesive.

25. Bi-component or multi-component adhesive comprising at least one coagulant according to any of claims 1 to 12 or at least one solution containing a coagulant of this type according to any of claims 13 to 23.

26. Adhesive according to claim 25, characterised in that it is bi-component adhesive, the coagulant according to any of claims 1 to 12 or the solution containing a coagulant of this type according to any of claims 13 to 23 forming the first coagulating component, the second component being the adhesive component.

27. Adhesive according to claim 26, characterised in that the second adhesive component contains polychloroprene or poly(2-chloro-1,3-butadiene) capable of coagulating by reduction of the pH.

28. Method of adhesion, characterised in that it consists in combining by co-spraying the coagulating component and adhesive component of a bi-component adhesive according to claim 26 in order to obtain a totally homogeneous adhesive film disposed on at least one of the two parts or faces of the elements to be bonded together, then in bringing said adhesive-coated parts or face(s) into contact.

29. Bonded product which can be obtained by the method according to claim 28.

30. Device for carrying out the method according to claim 28, characterised in that it is made in the form of a gun having a first and a second coaxial or substantially coaxial nozzle, the first nozzle being connected to a reservoir containing the first, coagulating component and the second nozzle being connected to a reservoir containing the second, adhesive component.
